(19) United States
(12) Patent Application Publication
(10) Pub. No.: US 2026/0329982 A1
(43) Pub. Date: Oct. 22, 2026

(54) BLOCKCHAIN-BASED AI MODEL GOVERNANCE SYSTEM AND METHOD

(71) Applicant: Forward Edge-AI, Inc., San Antonio, TX (US)

(72) Inventors: Eric A. Adolphe, San Antonio, TX (US); Kevin L. Jackson, Manassas, VA (US); Thomas Summe, San Antonio, TX (US)

(21) Appl. No.: 19/649,903

(22) Filed: Apr. 16, 2026

Related U.S. Application Data
(63) Continuation-in-part of application No. 19/649,696, filed on Apr. 16, 2026.
(60) Provisional application No. 63/791,033, filed on Apr. 18, 2025.

(51) Int. Cl. G06F 21/16; G06F 21/10; G06F 21/62; H04L 9/00

(52) U.S. Cl. CPC G06F 21/16; G06F 21/107; G06F 21/629; H04L 9/50

(57) ABSTRACT

An embodiment of the present invention is directed to a blockchain-based governance system for AI models, comprising: a blockchain ledger configured to record transactions related to AI model updates, modifications, and access; a model card database configured to store metadata, training dataset information, performance benchmarks, and version history for AI models; an advanced watermarking mechanism configured to embed unique identifiers in AI model training data and outputs; smart contracts configured to automate validation and enforcement of model integrity policies, licensing agreements, and compliance checks; and a graphical user interface configured to provide an interactive visualization of AI model lineage. The system enables transparent and immutable recordkeeping of AI model evolution, ensuring verifiable audit trails and reducing risks associated with adversarial AI attacks, data poisoning, and unauthorized modifications.

### CROSS-REFERNCE TO RELATED APPLICATIONS

This application is a continuation-in-part of U.S. application Ser. No. 19/649,696, titled “Methods and Systems for Tamper-Resistant Federated Artificial Intelligence Compliance and Governance using Secure Multiparty Computation, Cryptographic Watermarking, and Model Drift Detection in Disconnected or Adversarial Environments,” filed Apr. 16, 2026, which claims priority to U.S. Application No. 63/791,033, titled “Methods and Systems for Tamper-Resistant Federated Artificial Intelligence Compliance and Governance using Secure Multiparty Computation, Cryptographic Watermarking, and Model Drift Detection in Disconnected or Adversarial Environments,” filed Apr. 18, 2025, which are hereby incorporated by reference in their entirety.

### STATEMENT AS TO FEDERALLY SPONSORED RESEARCH

This invention was made with Government support under the Small Business Innovation Research (SBIR) Funding Award No. 2327618 awarded by the National Science Foundation (NSF). The Government has certain rights in this invention.

### FIELD OF INVENTION

The present disclosure relates to artificial intelligence (“AI”) governance systems, and more particularly to a blockchain-based system and method for tracking and validating AI model lineage, training data provenance, and operational updates.

### BACKGROUND

Artificial intelligence (AI) and machine learning (ML) technologies have become increasingly prevalent across various industries, transforming the way organizations operate and make decisions. As these technologies continue to evolve and become more sophisticated, there is a growing need for robust governance systems to ensure their responsible development, deployment, and use.

AI models are complex systems that rely on vast amounts of data for training and operation. The quality, integrity, and provenance of this data are crucial factors in determining the reliability and effectiveness of AI models. However, tracking the lineage of AI models and their associated training data can be challenging, especially as models undergo multiple iterations and modifications over time. For example, AI models are trained using Internet data which often lacks verification and pedigree and may contain false information. In addition, there is no standardized documentation process for AI/ML models accepted by the industry, thereby leading to inconsistencies.

Traditional methods of managing AI model development and deployment often lack transparency and traceability. This can lead to difficulties in auditing, verifying, and maintaining the integrity of AI systems. Furthermore, the potential for adversarial attacks, data poisoning, and unauthorized modifications poses significant risks to the security and reliability of AI models.

As AI technologies become more integrated into critical decision-making processes, regulatory bodies and stakeholders are increasingly demanding greater accountability and transparency in AI systems.

As the field of AI continues to advance, there is an ongoing need for improved methods and systems that can enhance the transparency, security, and accountability of AI model development and deployment. Such solutions would not only benefit organizations developing and using AI technologies but also help build trust among end-users and regulatory bodies.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a blockchain-based governance system for AI models is provided. The system includes a blockchain ledger configured to record transactions related to AI model updates, modifications, and access, wherein the blockchain ledger is distributed across multiple nodes to ensure immutability and transparency of recorded transactions. The system also includes a model card database configured to store metadata, training dataset information, performance benchmarks, and version history for AI models. The system further includes a watermarking mechanism configured to embed unique identifiers in AI model training data and outputs. Additionally, the system includes smart contracts configured to automate validation and enforcement of model integrity policies, licensing agreements, and compliance checks. The system also includes a graphical user interface configured to provide an interactive visualization of AI model lineage and provenance of the AI model training data.

According to other aspects of the present disclosure, the system may include one or more of the following features. The system may be configured to continuously monitor AI model updates and automatically flag inconsistencies, unauthorized modifications, and potential adversarial manipulations. The blockchain ledger may be configured to ensure that all changes to an AI model are recorded permanently and immutably. The system may be configured to allow for forensic audits and regulatory compliance verification. The advanced watermarking mechanism may be configured to ensure provenance tracking and intellectual property protection. The graphical user interface may be configured to ensure transparency and ease of governance.

According to another aspect of the present disclosure, a method for governing AI models using a blockchain-based system is provided. The method includes recording transactions related to AI model updates, modifications, and access on a blockchain ledger distributed across multiple nodes to ensure immutability and transparency of recorded transactions. The method also includes storing metadata, training dataset information, performance benchmarks, and version history for AI models in a model card database. The method further includes embedding unique identifiers in AI model training data and outputs using an advanced watermarking mechanism. Additionally, the method includes automating validation and enforcement of model integrity policies, licensing agreements, and compliance checks using smart contracts. The method also includes providing an interactive visualization of AI model lineage and provenance of the AI model training data through a graphical user interface.

According to other aspects of the present disclosure, the method may include one or more of the following features. The method may include continuously monitoring AI model updates and automatically flagging inconsistencies, unauthorized modifications, and potential adversarial manipulations. The method may include ensuring that all changes to an AI model are recorded permanently and immutably on the blockchain ledger. The method may include allowing for forensic audits and regulatory compliance verification. The method may include ensuring provenance tracking and intellectual property protection through the advanced watermarking mechanism. The method may include ensuring transparency and ease of governance through the graphical user interface.

The foregoing general description of the illustrative embodiments and the following detailed description thereof are merely exemplary aspects of the teachings of this disclosure and are not restrictive.

### BRIEF DESCRIPTION OF FIGURES

In order to facilitate a fuller understanding of the invention, reference is made to the attached drawings. The drawings should not be construed as limiting the invention, but are intended only to illustrate different aspects and embodiments of the invention.

FIG. 1 illustrates a block diagram of a data management system, according to an embodiment of the present invention.

FIG. 2 illustrates a flowchart for an AI model governance system, according to an embodiment of the present invention.

FIG. 3 illustrates a flowchart for a training data metagraph algorithm, according to an embodiment of the present invention.

FIG. 4 illustrates a block diagram of an AI model governance system, according to an embodiment of the present invention.

FIG. 5 illustrates a block diagram of an AI/ML model governance system, according to an embodiment of the present invention.

FIG. 6 illustrates a system diagram showing model version progression and associated training data relationships, according to an embodiment of the present invention.

FIG. 7 illustrates a block diagram of a model tracking system and incident investigation module, according to an embodiment of the present invention.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

An embodiment of the present invention is directed to a blockchain-based governance system for AI models that records, verifies, and secures model lineage, training data provenance, and operational updates. The governance system leverages blockchain smart contracts, advanced data watermarking, and AI model card documentation to ensure transparent and immutable recordkeeping of AI model evolution. An embodiment of the present invention provides a verifiable audit trail for AI models, reducing risks associated with adversarial AI attacks, data poisoning, and unauthorized modifications.

An embodiment of the present invention is directed to development of an inactive audit log system. According to an exemplary embodiment, an inactive audit log system may provide a comprehensive, immutable, and cryptographically secure record of AI model transactions. This system ensures that AI model updates, data provenance, and decision-making processes are transparently recorded and auditable. Unlike traditional logging mechanisms, this system is designed to store logs in an inactive state, meaning they cannot be altered or tampered with post-creation. The implementation of blockchain-based ledgering further strengthens this system by ensuring decentralized, tamper-proof verification of all AI-related activities thereby aligning with various governance practices (e.g., Responsible AI), ensuring traceability, compliance, and security in AI-driven operations.

An embodiment of the present invention is directed to a multi-layered AI model validation. Ensuring the reliability of AI models in mission-critical environments requires a multi-layered AI model validation process. A robust AI validation framework of an embodiment of the present invention combines adversarial testing, resilience analysis, and accuracy benchmarking. An embodiment of the present invention incorporates federated validation techniques and differential privacy methods to ensure AI models remain uncompromised and performant even in contested spaces. This validation process integrates continuous monitoring mechanisms to detect model drift, data poisoning, and/or adversarial influence, enabling proactive security patching and governance enforcement.

An embodiment of the present invention is directed to enhanced AI lineage tracking through an interactive user interface. For example, the interactive user interface may support a genealogical visualization system for AI model lineage tracking to ensure full traceability and accountability and further support an interactive and transparent record of AI development cycles. According to one example, the interactive user interface may include a wiki-style GUI interface (or other collaborative interface) that enables users to trace AI model evolution, compare different model versions, and assess how training data influences decision-making. Analysts may identify potential biases, track updates, and maintain a hierarchical view of AI model history, and prevent unauthorized modifications.

An embodiment of the present invention is directed to real-time model drift detection. AI models deployed in complex and critical applications (e.g., space and defense) often experience concept drift, where real-world data distributions change over time, leading to degraded model performance. To address this, an embodiment of the present invention may incorporate real-time model drift detection mechanisms that continuously analyze incoming data streams, compare them to historical patterns, and flag deviations. The real-time model drift detection ensures that AI models may autonomously adapt to evolving operational conditions while preventing model obsolescence and performance degradation. Integrating explainable AI (XAI) frameworks enhances interpretability, allowing operators to understand why a model's performance is shifting and take corrective action.

An embodiment of the present invention is directed to providing a secure federated learning framework. As AI models increasingly rely on distributed data sources, ensuring privacy, security, and compliance becomes a challenge. An embodiment of the present invention addresses this through the development of a secure federated learning framework, which allows AI models to train on decentralized data sources without directly sharing sensitive information. This ensures that various AI systems (including military and defense systems) may learn from real-world data in contested environments without exposing proprietary or classified datasets. The use of homomorphic encryption, differential privacy, and secure multiparty computation (SMPC) ensures that data integrity may be preserved while enabling AI model improvements. This further supports data-centric security initiatives, ensuring AI-driven operations remain both secure and resilient.

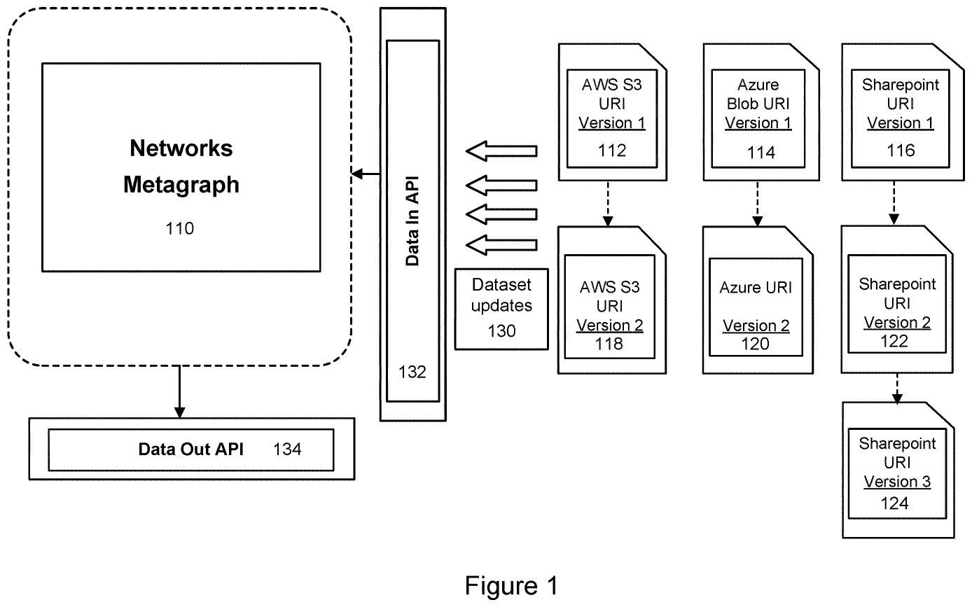

FIG. 1 illustrates a block diagram of a data management system, according to an embodiment of the present invention. As shown in FIG. 1, a data management system may include Networks Metagraph 110. Networks Metagraph 110 may be connected to multiple storage URIs through a data interface, as shown by Data In API 132. The storage URIs may be arranged in a hierarchical structure, with a first storage URI 112, a second storage URI 114, and a third storage URI 116 positioned in a first tier. A second tier may include a fourth storage URI 118, a fifth storage URI 120, and a sixth storage URI 122. A seventh storage URI 124 may be positioned in a third tier connected to the sixth storage URI 122. Other structures may be implemented.

Networks Metagraph 110 may process and manage data flowing through the system. For example, Data In API 132 may facilitate data flow between Networks Metagraph 110 and the various storage URIs. Data In API 132 may receive dataset updates 130, allowing updated information to be distributed through the system.

An output interface, as shown by Data Out API 134, may provide a pathway for data output from Networks Metagraph 110. Data Out API 134 may enable data retrieval and export from Networks Metagraph 110. The storage URIs may be interconnected, with data flowing between different tiers through connected pathways.

According to an embodiment of the present invention, a blockchain ledger may record transactions related to updates, modifications, and/or access of data within the system. The blockchain ledger may provide a secure and immutable record of changes and interactions within the data management system.

Networks Metagraph 110 may serve as a central processing component, receiving data through the data interface, as shown by 132, and providing processed output through the output interface, as shown by 134. This structure allows for efficient data management, processing, and distribution across the various storage URIs within the system. Networks Metagraph 110 may represent a module application layer having independent subnets that define their own logic, tokens and data structures. In addition, Networks Metagraph 110 may represent a custom, application-specific blockchain.

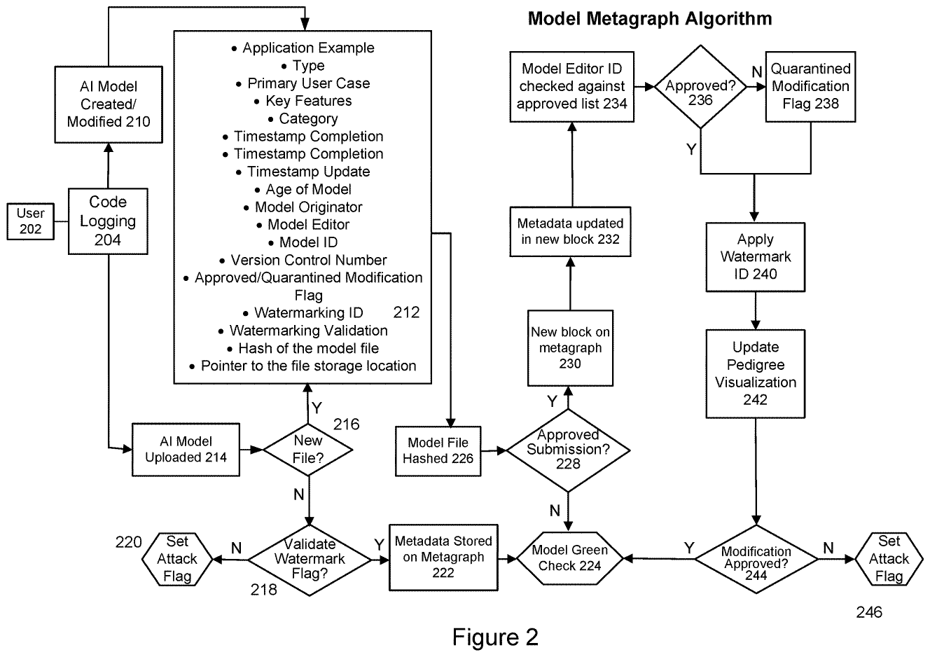

FIG. 2 illustrates a flowchart for an AI model governance system, according to an embodiment of the present invention. An AI model governance system may implement a workflow as illustrated in FIG. 2. The workflow may begin with a user 202 initiating the process. The user 202 may interact with the system through a user interface via a communication network.

Following user initiation, users may submit jobs and code through code logging 204. Code logging 204 may record the code being executed to create or modify an AI model 210. This logging process may help maintain a record of all changes made to the AI model 210.

Once an AI model 210 is created or modified, the system may perform a model upload 214. During the model upload 214 process, the system may create a metadata block 212. The metadata block 212 may contain information such as application examples, model type, primary use cases, key features, category, timestamps, age of model, model originator, model ID, version control number, and modification flags. The information shown in 212 is illustrative only and may contain other variations.

After the AI model is uploaded, as shown by 214, the system may conduct a file verification at 216. The file verification 216 may determine whether the uploaded file is new or an existing file with modifications. If the file is new, the system may proceed to generate a model hash at 226. The model hash at 226 may create a unique identifier for the model, which may be used for verification purposes.

If the file is not new, the system may perform watermark validation, as shown by 218. Watermark validation may verify the integrity of the model by checking for a previously applied digital watermark. If the watermark validation fails at 218, the system may set an attack flag at 220, indicating a potential security breach or unauthorized modification.

Upon successful watermark validation 218, the system may store the metadata on a Metagraph at 222. Following metadata storage, the system may perform a model check at 224 to ensure the integrity and consistency of the stored model.

The system may then proceed to submission verification, as shown by 228. Submission verification may involve checking whether the submitted model meets predefined criteria for approval. If approved, the system may create a new metagraph block at 230 and update the metadata at 232.

Following metadata update 232, the system may perform editor verification, as shown by 234. Editor verification 234 may check whether the entity making the modifications is on an approved list of editors. This may be followed by approval verification 236, which may determine whether the specific modifications are approved.

If the modifications are not approved, the system may set a quarantined modification flag, as shown by 238. For approved modifications, the system may apply a watermark identifier 240 to the model. The watermark identifier 240 may serve as a digital signature for the approved version of the model.

After applying the watermark identifier 240, the system may update the pedigree of the model, as shown by 242. Pedigree update may involve recording the lineage and history of modifications made to the model.

The final step in the workflow may be modification approval at 244. If the modification is approved, the process may complete. If not approved, the system may set an attack indicator 246, flagging potential unauthorized or malicious modifications.

In some cases, a monitor engine may continuously monitor AI model updates throughout this workflow. The monitor engine may flag inconsistencies, unauthorized modifications, and potential adversarial manipulations. This continuous monitoring may enhance the security and integrity of the AI model governance system.

A smart contract module may automate various aspects of this workflow. The smart contract module may validate and enforce model integrity policies, licensing agreements, and compliance checks. This automation may streamline the governance process and ensure consistent application of rules and policies across all AI models managed by the system.

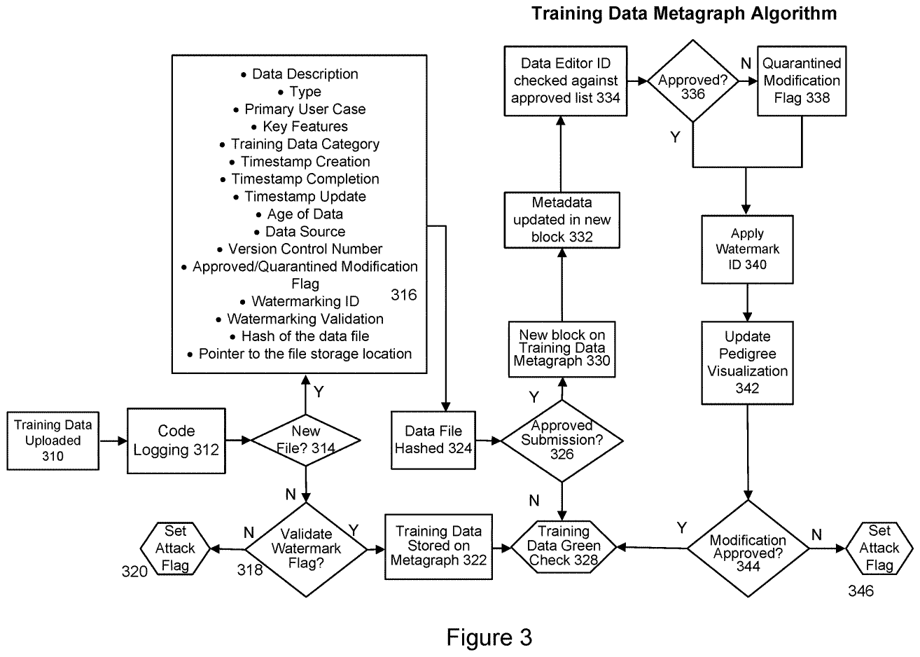

FIG. 3 illustrates a flowchart for a training data metagraph algorithm, according to an embodiment of the present invention. A training data metagraph algorithm may be implemented as illustrated in FIG. 3. The algorithm may begin with training data being uploaded to the system, as shown by 310. Following the upload, code logging 312 may be performed to record the code being executed during the process. For example, users may submit jobs and code through code logging 312.

A new file decision 314 may determine whether the uploaded file is new or an existing file with modifications. If the file is new, the system may create a metadata block 316. The metadata block 316 may contain data descriptors including type, primary use case, key features, timestamps, and other relevant metadata elements. The information shown in 316 is illustrative only and may contain other variations.

If the file is not new, the system may perform watermark validation, as shown by 318. The watermark validation may verify the integrity of the training data by checking for a previously applied digital watermark. For example, a watermark module may embed unique identifiers in AI model training data and outputs to ensure provenance tracking and intellectual property protection. If the watermark validation fails at 318, the system may set an attack flag as shown by 320, indicating a potential security breach or unauthorized modification.

Upon successful watermark validation 318, the system may store the data in training data on a metagraph, as shown by 322. Following metadata storage, the system may perform a model check at 328 to ensure the integrity and consistency of the stored model.

As shown by 324, a data file hash may be generated to create a unique identifier for the training data file. The system may then proceed to submission approval 326. If approved, a new block may be created on the training data metagraph as shown by 330 and the metadata may be updated in a new block as shown by 332.

Following the metadata update at 332, the system may check the data editor ID against an editor approval list at 334. If approved at 336, the process may continue. If not approved, a quarantine modification flag may be set at 338.

For approved modifications, the system may apply a watermark identifier, at 340, to the training data. The watermark identifier may serve as a digital signature for the approved version of the training data.

After applying the watermark identifier at 340, the system may update the pedigree visualization as shown by 342. The pedigree visualization may provide a graphical representation of the training data lineage and modification history.

The final step in the algorithm may be a modification approval decision 344. If the modification is approved, the process may complete. If not approved, the system may set an attack flag indicator 346, flagging potential unauthorized or malicious modifications to the training data.

In some cases, a training data validator may use homomorphic encryption, differential privacy, and secure multiparty computation (SMPC) to ensure the privacy and security of the training data throughout the process. These techniques may allow for secure validation and processing of the training data without exposing sensitive information.

A typical user flow of a Machine Learning Operations (MLOps) lifecycle may include: finding a dataset, cleaning the dataset, building an ML Model, storing the ML Model, inferring the ML Model, and tracking the Model's performance.

Based on the Model performance metrics, ML engineers may tweak the ML models and incorporate newer ML models. For example, ML engineers often add synthetic/additive datasets to the original datasets. A Dataset Metagraph may seek to track all the changes in the Dataset to enable the ability to trace back the results and improve the transparency and efficiency of the MLOps life cycle.

The Dataset Metagraph may provide the provenance of the dataset by ingesting the pointer to the dataset location and providing an API to verify the hash to ensure the dataset is not compromised or corrupted. This allows business users to have full confidence in the Datasets, thereby improving the trust in AI applications.

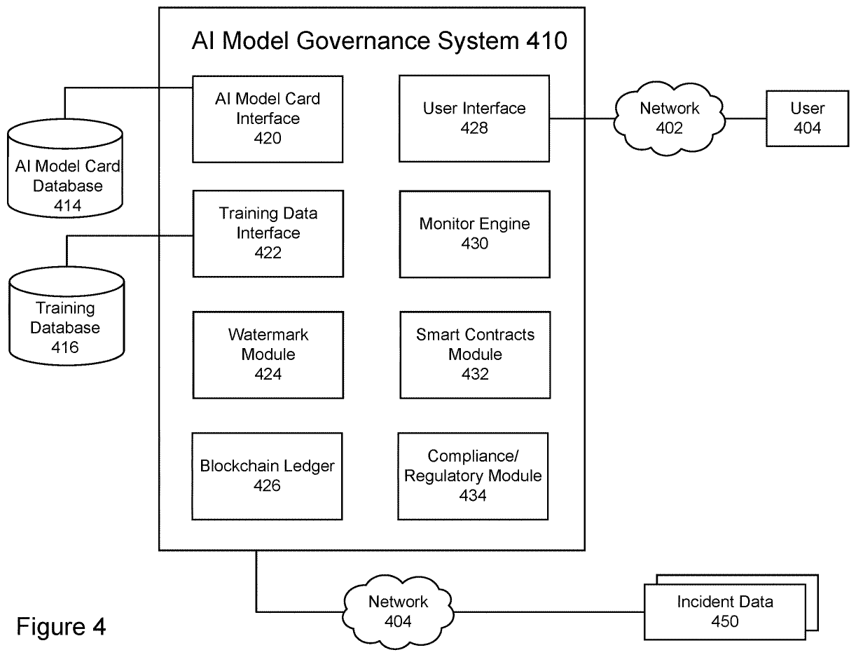

FIG. 4 illustrates a block diagram of an AI model governance system, according to an embodiment of the present invention. In some cases, AI Model Governance System 410 may be implemented as shown in FIG. 4. AI Model Governance System 410 may include multiple components connected through various communication networks and links.

AI Model Governance System 410 may communicate with a AI Model Card Database 414 and a Training Database 416. The AI Model Card Database 414 may store AI models, while the Training Database 416 may store training data used to develop and refine the AI models.

AI Model Card Interface 420 may provide access to AI Model Card Database 414. For example, AI Model Card Database 414 may include a structured repository that records metadata, training datasets, performance benchmarks, and version history of AI models.

AI Model Card Interface 420 may include specific metadata fields such as model performance benchmarks and version history. These metadata fields may allow for detailed tracking and documentation of AI model evolution over time.

An embodiment of the present invention is directed to standardizing AI performance metrics by developing a comprehensive model card framework. This framework aligns with industry best practices, providing a structured method for evaluating AI performance, transparency, and reliability. In addressing the challenges of model and data drift, an embodiment of the present invention may integrate real-time monitoring and drift detection capabilities, ensuring that AI models maintain their accuracy and relevance over time.

A Training Data Interface 422 may provide access to the Training Database 416. Training Data Interface 422 may facilitate the management and retrieval of training datasets used in AI model development.

AI Model Governance System 410 may include a Watermark Module 424 that applies digital watermarks to AI models and training data to ensure provenance tracking and intellectual property protection. For example, Watermark Module 424 may embed unique identifiers in AI model training data and outputs to ensure accurate tracking.

To enhance AI model security, Watermark Module 424 may apply multi-layer blind watermarking, which embeds invisible, resilient digital signatures into AI models to verify authenticity and detect unauthorized alterations. This protects against model inversion attacks, adversarial manipulation, and unauthorized model duplication to ensure that adversarial actors cannot exploit or steal AI systems. Unlike traditional watermarking, multi-layer blind watermarking is resilient to modifications, making it ideal for defense applications where AI models may be deployed in contested environments. For example, each model update may be embedded with a unique cryptographic signature, allowing the system to detect tampered or unverified models before deployment.

Blockchain Ledger 426 may be incorporated into AI Model Governance System 410. Blockchain Ledger 426 may record transactions related to AI model updates, modifications, and access, providing a secure and tamper-proof record of model governance activities. Blockchain Ledger 426 ensures that all changes to an AI model are recorded permanently and immutably, allowing for forensic audits and regulatory compliance verification.

The blockchain-based AI Model Governance System 410 is directed to ensuring secure, verifiable, and tamper-proof management of ML models used in various complex and operations, e.g., defense and space operations. Blockchain Ledger 426 implements immutable blockchain records to track AI model provenance, train data lineage, and update history, ensuring that every change is transparent and auditable.

An embodiment of the present invention is directed to AI governance, security, and operational efficiency, ensuring the verifiable integrity of AI models and training data. Through the development of a robust AI model lineage framework, an embodiment of the present invention establishes a repeatable and verifiable process for tracking the origin, evolution, and training data of AI models. This ensures that AI systems remain auditable and aligned with regulatory compliance standards.

User Interface 428 allows various interactions with AI Model Governance System 410 through communication network 402. User Interface 428 may provide an interactive visualization of AI model lineage, ensuring transparency and ease of governance for users accessing the system through a user device 404. For example, User Interface 428 may include features for comparing different model versions, highlighting changes in performance metrics, and displaying the provenance of training data.

For example, User Interface 428 may provide an interactive, wiki-style AI model lineage visualization tool to enhance observability and traceability across the AI lifecycle. This genealogical visualization tool provides real-time insights into model evolution, displaying who trained a model, what data was used, when updates were applied, and how performance metrics have changed over time. By integrating graph-based lineage tracking and dynamic model comparisons, an embodiment of the present invention enables AI engineers and analysts to assess AI model drift, data shifts, and emerging security risks. This feature also enables interactive audit trails, making it possible to identify potential vulnerabilities or misconfigurations in AI-driven decision-making systems quickly. The visualization tool further ensures AI transparency, accountability, and compliance with various security protocols.

AI Model Governance System 410 may include a Monitor Engine 430. The Monitor Engine 430 may continuously monitor AI model updates, automatically flagging inconsistencies, unauthorized modifications, and potential adversarial manipulations.

Smart Contracts Module 432 may be implemented within AI Model Governance System 410. Smart Contracts Module 432 may automate the validation and enforcement of model integrity policies, licensing agreements, and compliance checks.

The blockchain-based AI Model Governance System 410 enables smart contracts for automated AI compliance monitoring, ensuring that only authorized model updates are deployed while preventing adversarial interventions. The decentralized nature of blockchain ensures that no single entity can manipulate AI models undetected, aligning with zero-trust security principles. Additionally, AI Model Governance System 410 may integrate cryptographic signatures and role-based access control to reinforce security, ensuring that AI models deployed in autonomous space missions and battlefield analytics remain trustworthy and accountable.

In advancing the use of AI in virtual and augmented reality applications, an embodiment of the present invention is directed to a Simulation Balance testing framework that verifies AI models used in various environments. This ensures that AI-driven simulations remain consistent, realistic, and free from bias. Additionally, the testing framework supports an enhanced AI model development process, aligning AI governance with various Responsible AI Toolkit. By integrating blockchain technology, model development visibility, and smart contract governance, an embodiment of the present invention ensures that AI systems deployed in defense, space, and critical commercial applications remain secure, auditable, and compliant with ethical AI standards.

AI Model Governance System 410 may incorporate a Compliance/Regulatory Module 434 that ensures compliance with specific standards such as GDPR, emerging AI laws as well as industry/organization specific requirements or standards. This module may help organizations maintain regulatory compliance in their AI model governance practices.

According to an embodiment of the present invention, AI Model Governance System 410 may receive Incident Data 450 through the communication network 404. Incident Data 450 may represent data from a service or a provider. For example, Incident Data 450 may represent data from various sensors that has been cryptographically signed, securely transmitted and stored immutably. The incident data may include emergency vehicle sensor data, foot traffic, chain of custody reports, mobile devices, mining performance data, sensitive communications, etc. Different models may be created for various applications, such as ambulances, police cars or specific locations such as New York City or Manassas, Virginia. Models may be used to predict outcomes of incidents, such as determining whether a municipality or citizen was at fault in an accident. The results of the models may vary based on various factors including type of incident, location, local laws, etc. AI Model Governance System 410 may verify the model being used and the data used to train the model and further verify and maintain a chain of custody for data related to the incidents. This verification ensures that when incidents are presented, the data linked to a model may be reliably used as evidence.

The components of the AI Model Governance System 410 may work together to provide comprehensive governance and tracking of AI models and their associated training data. The interfaces and modules may enable model management, verification, and regulatory compliance capabilities while maintaining secure access through communication networks.

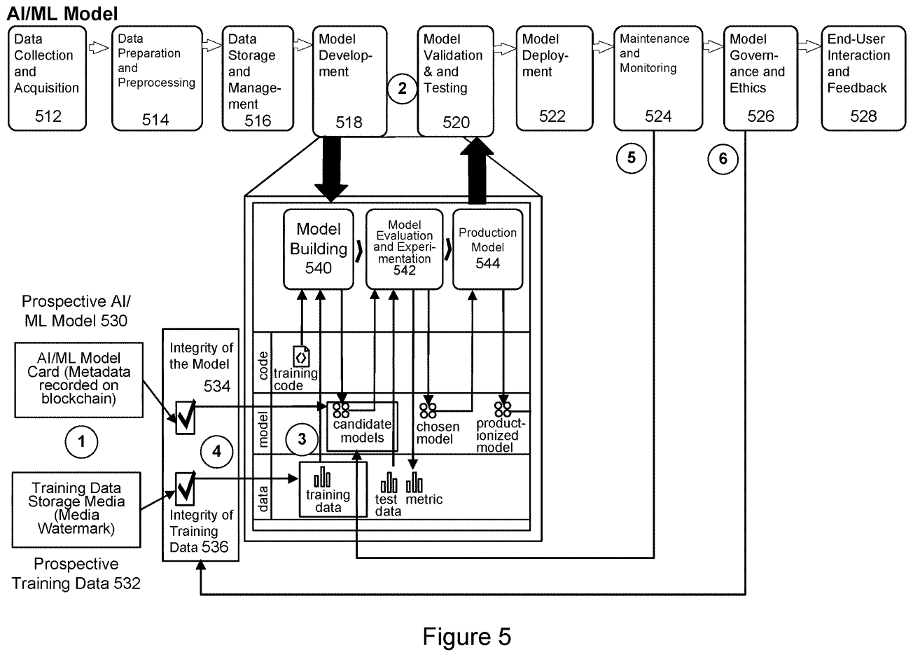

FIG. 5 illustrates a block diagram of an AI/ML model governance system, according to an embodiment of the present invention. In some cases, an AI/ML model governance system may include multiple interconnected modules as illustrated in FIG. 5. The system may begin with data collection and acquisition 512 that gathers relevant data for model development and training. The data collection and acquisition 512 may connect to a data preparation and preprocessing 514, which may preprocess and clean the collected data.

The data preparation and preprocessing 514 may feed into data storage and management 516. The data storage and management 516 may securely store and manage the prepared data for use in model development and training.

Model development 518 may receive input from the data storage and management 516. Model development 518 may interact with a model building component 540, a model evaluation and experimentation component 542, and a production model component 544. These components may work together to process candidate models, training data, and test metric data to produce productionized models. In some cases, model development 518 may incorporate adversarial testing and resilience analysis to enhance the robustness of the developed models.

The system of FIG. 5 may support model validation and testing 520 that connects to model development 522. The model validation and testing 520 may incorporate federated validation techniques and differential privacy methods to ensure the integrity and privacy of the validated models.

Following validation, model deployment 522 may prepare the validated models for operational use. Model deployment 522 may connect to maintenance and monitoring 524, which may oversee the performance of deployed models. In some cases, maintenance and monitoring 524 may include real-time model drift detection mechanisms to identify and address changes in model performance over time.

Model governance and ethics 526 may receive input from maintenance and monitoring 524. In addition, model governance and ethics 526 may oversee the ethical and regulatory compliance of the AI/ML models. In some cases, the model governance and ethics 526 may integrate explainable AI (XAI) frameworks to enhance the interpretability of model decisions and behaviors.

The system may include user interaction, as shown by end-user interaction and feedback 528 at the end of the main processing chain. End-user interaction and feedback 528 may facilitate communication between the governance system and end-users, allowing for feedback and interaction with the managed models.

A prospective AI/ML model 530 and prospective training data storage 532 may provide inputs to the system. These components may represent new models or data sets being considered for integration into the governance system.

The system may incorporate a model integrity validator 534 and a training data validator 536. These validators may verify the integrity and quality of incoming models and training data before they are processed by the governance system. With an embodiment of the present invention, an end user may decide whether to use a specific AL/ML model appropriately based on verifiable artifacts regrading the integrity of the model and training data. Further, the end user may determine the applicability of recorded and verified changes to the identified use case.

The AI/ML model governance system may implement a workflow where data and models flow through validation, development, and governance stages. The modules may be arranged in a sequential flow, with feedback paths allowing for iterative refinement and monitoring of the AI/ML models throughout their lifecycle.

As demonstrated in FIG. 5, an embodiment of the present invention may provide an improved model selection process as shown by (1), improved model development, validation and testing time as shown by (2), improved model documentation as shown by (3), reduction in cyber risk as shown by (4), improve system monitoring as shown by (5) and improved model governance as shown by (6).

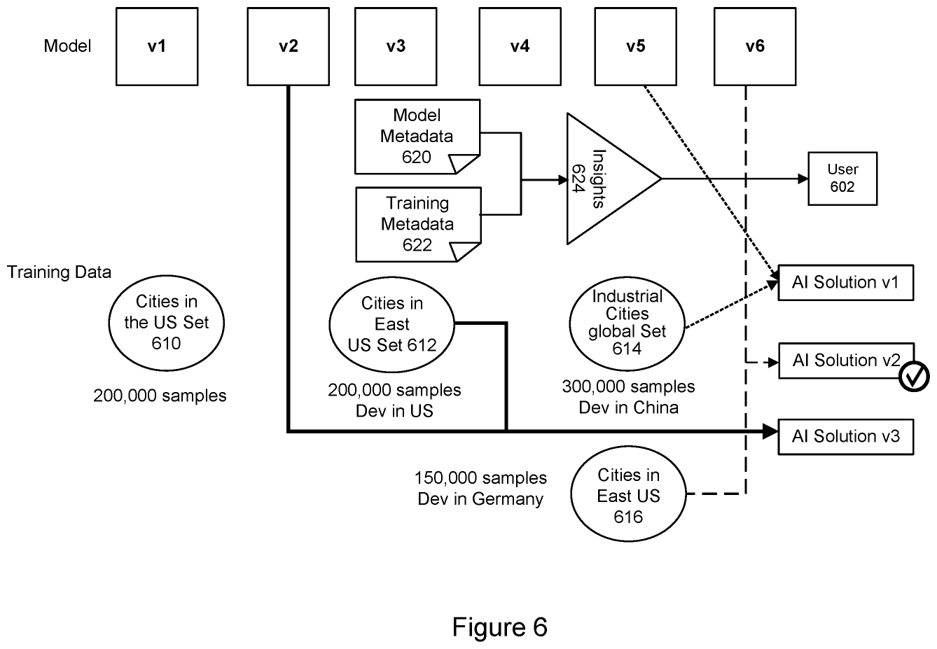

FIG. 6 illustrates a system diagram showing model version progression and associated training data relationships, according to an embodiment of the present invention. In some cases, an AI model governance system may implement model version progression and associated training data relationships as illustrated in FIG. 6. The system may include multiple model versions arranged sequentially.

An initial model version v1 may represent the starting point of the model development process. A second model version v2 may be connected to a training dataset 610. The training dataset 610 may contain data from cities in the US with 200,000 samples.

A fifth model version v5 may be linked to a global dataset 614. The global dataset 614 may contain data from industrial cities with 300,000 samples developed in China.

A sixth model version v6 may be associated with an east region subset 616. The east region subset 616 may contain data, such as 150,000 sample set developed in Germany.

The model metadata 620 and training metadata 622 may contain information about the model's characteristics and the training data used, respectively. Insights/validation 624 may receive inputs from model metadata 620 and training metadata 622. In some cases, insights/validation 624 may provide cryptographic signatures for data authenticity.

The system may output multiple AI solutions, including AI Solution v1, AI Solution v2, and AI Solution v3. These solutions may represent different iterations or applications of the model versions. An embodiment of the present invention may provide verifiable, traceable, and immutable data to document and support the most appropriate solution. In this example, the most appropriate solution is identified as AI Solution v2. By documentation the data used for each model, consistency may be achieved thereby allowing for an effective comparison between different models and solutions.

The diagram in FIG. 6 may illustrate the relationships between different model versions and their associated datasets. The connections between components may be represented by solid and dashed lines, indicating various types of relationships or data flows.

The system may demonstrate how model versions progress and interact with different datasets throughout the development process. This progression may allow for traceability and understanding of how each model version relates to specific training data and metadata.

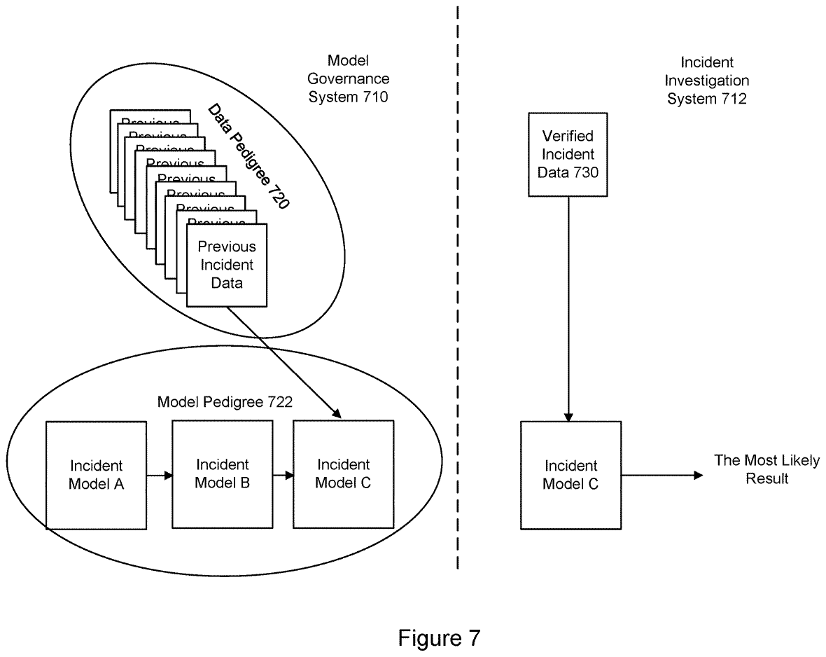

FIG. 7 illustrates a block diagram of a model governance system and incident investigation system, according to an embodiment of the present invention. In some cases, Model Governance System 710 and Incident Investigation System 712 may be implemented as illustrated in FIG. 7. Model Governance System 710 may provide Data Pedigree 720 that maintains records of previous incident data and model lineage information. Data Pedigree 720 may connect to a series of incident models arranged in sequence, showing the progression and relationships between different model versions, as represented by Model Pedigree 722. Data Pedigree 720 illustrates the data that was used to train a series of models shown in Model Pedigree 722.

Incident Investigation System 712 may receive verified incident data 730 and process the verified incident data 730 using an incident model C. The verified incident data 730 may flow into the incident model to generate the most likely result based on the analysis of the verified incident data 730. By using verified data and models, an embodiment of the present invention provides the most likely result for specific incidents. By ensuring trustworthiness in both models and training data, an embodiment of the present invention provides reliable predictions and outcomes for incident analysis.

For example, Incident Investigation System 712 may use a model of specific intersections to evaluate the verified incident data 730. This model may incorporate details such as traffic light timing, road layout, and historical accident data for the particular intersection where an incident occurred.

Data Pedigree 720 may maintain the historical record and lineage of models used in the incident investigation process. This may include tracking changes and updates to the models over time, as well as recording the sources and modifications of training data used to develop these models.

An embodiment of the present invention is directed to a governance system for AI models to ensure verifiable audit trails for model lineage and training data provenance and further reduces risks associated with using AI models. The governance system collects, records and verifies metadata about models and training data. This enables users to assess risk tolerance when selecting models and training data combinations. An embodiment of the present invention is directed to enhancing reliability and trust in AI models by providing comprehensive verifiable information about their development and the data used.

To counter adversarial AI threats, an embodiment of the present invention provides model pedigree visibility through blockchain-based governance that significantly enhances model security and integrity. By implementing these measures, an embodiment of the present invention reduces the risk of unauthorized modifications, adversarial attacks, and data manipulation. Additionally, AI model development efficiency may be greatly improved through the establishment of a validated repository of AI models with a verifiable development pedigree. This approach further streamlines AI deployment, minimized duplication of effort, and accelerated the adoption of reliable models.

Model Governance System 710 may support Incident Investigation System 712 by providing validated models with traceable development history. This may allow for greater transparency and accountability in the incident investigation process.

The flow of information may move from Data Pedigree 720 through the model sequence to enable analysis of the verified incident data 730 and determine the most likely result. This process may help ensure that incident investigations are based on reliable, up-to-date models with known provenance.

In some cases, Model Governance System 710 may interface with the blockchain ledger to record and verify changes to the incident models. This may provide an additional layer of security and traceability in the model development and incident investigation processes.

Incident Investigation System 712 may leverage the smart contract module to automate certain aspects of the investigation process, such as selecting the appropriate model based on the type of incident and the location where the verified incident data 730 was collected.

A number of implementations have been described. Nevertheless, it will be understood that various modifications may be made without departing from the spirit and scope of the disclosure. Accordingly, other implementations are within the scope of the following claims.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A blockchain-based governance system for AI models, comprising:
a blockchain ledger configured to record transactions related to AI model updates, modifications, and access, wherein the blockchain ledger is distributed across multiple nodes to ensure immutability and transparency of recorded transactions;
a model card database configured to store metadata, training dataset information, performance benchmarks, and version history for AI models;
a watermarking mechanism configured to embed unique identifiers in AI model training data and outputs;
at least one smart contract configured to automate validation and enforcement of model integrity policies, licensing agreements, and compliance checks; and
a graphical user interface configured to provide an interactive visualization of AI model lineage and provenance of the AI model training data.

2. The blockchain-based governance system of claim 1, further comprising a monitor engine configured to continuously monitor AI model updates and automatically flag inconsistencies, unauthorized modifications, and potential adversarial manipulations.

3. The blockchain-based governance system of claim 2, wherein the monitor engine is further configured to detect model drift and data poisoning attempts.

4. The blockchain-based governance system of claim 1, wherein the watermarking mechanism utilizes a multi-layer blind watermarking technique to embed the unique identifiers.

5. The blockchain-based governance system of claim 1, wherein the model card database includes fields for model performance metrics, ethical considerations, and intended use cases.

6. The blockchain-based governance system of claim 5, wherein the graphical user interface is configured to display the model performance metrics, ethical considerations, and intended use cases for each AI model version.

7. The blockchain-based governance system of claim 6, wherein the graphical user interface provides a comparative view of multiple AI model versions, highlighting changes in performance metrics and ethical considerations across versions.

8. A method for governing AI models using a blockchain-based system, comprising:
recording transactions related to AI model updates, modifications, and access on a blockchain ledger distributed across multiple nodes to ensure immutability and transparency of recorded transactions;
storing metadata, training dataset information, performance benchmarks, and version history for AI models in a model card database;
embedding unique identifiers in AI model training data and outputs using a watermarking mechanism;
automating validation and enforcement of model integrity policies, licensing agreements, and compliance checks using smart contracts; and
providing an interactive visualization of AI model lineage and provenance of the AI model training data through a graphical user interface.

9. The method of claim 8, further comprising continuously monitoring AI model updates and automatically flagging inconsistencies, unauthorized modifications, and potential adversarial manipulations.

10. The method of claim 9, wherein the continuous monitoring includes detecting model drift and data poisoning attempts.

11. The method of claim 8, wherein embedding unique identifiers comprises utilizing a multi-layer blind watermarking technique.

12. The method of claim 8, wherein storing metadata in the model card database includes recording model performance metrics, ethical considerations, and intended use cases for each AI model version.

13. The method of claim 12, wherein providing an interactive visualization comprises displaying the model performance metrics, ethical considerations, and intended use cases for each AI model version through the graphical user interface.

14. The method of claim 13, wherein the graphical user interface provides a comparative view of multiple AI model versions, highlighting changes in performance metrics and ethical considerations across versions.

15. A non-transitory computer-readable medium storing instructions that, when executed by a processor, cause the processor to perform operations for governing AI models, the operations comprising:
recording transactions related to AI model updates, modifications, and access on a blockchain ledger distributed across multiple nodes to ensure immutability and transparency of recorded transactions;
storing metadata, training dataset information, performance benchmarks, and version history for AI models in a model card database;
embedding unique identifiers in AI model training data and outputs using a watermarking mechanism;
automating validation and enforcement of model integrity policies, licensing agreements, and compliance checks using smart contracts; and
generating an interactive visualization of AI model lineage and provenance of the AI model training data for display on a graphical user interface.

16. The non-transitory computer-readable medium of claim 15, wherein the operations further comprise continuously monitoring AI model updates and automatically flagging inconsistencies, unauthorized modifications, and potential adversarial manipulations.

17. The non-transitory computer-readable medium of claim 16, wherein continuously monitoring AI model updates includes detecting model drift and data poisoning attempts.

18. The non-transitory computer-readable medium of claim 15, wherein embedding unique identifiers comprises utilizing a multi-layer blind watermarking technique.

19. The non-transitory computer-readable medium of claim 15, wherein storing metadata in the model card database includes recording model performance metrics, ethical considerations, and intended use cases for each AI model version.

20. The non-transitory computer-readable medium of claim 19, wherein generating an interactive visualization comprises displaying the model performance metrics, ethical considerations, and intended use cases for each AI model version, and providing a comparative view of multiple AI model versions highlighting changes in performance metrics and ethical considerations across versions.
